(19) United States
(12) Patent Application Publication
(10) Pub. No.: US 2024/0259615 A1
(43) Pub. Date: Aug. 1, 2024

(54) APPLYING USER PROFILE SPECIFIC PRIVACY ON CONFIDENTIAL DATA WHILE SCREEN SHARING

(71) Applicant: International Business Machines Corporation, Armonk, NY (US)

(72) Inventor: Atul Ashok Waghmare, Pleasanton, CA (US)

(21) Appl. No.: 18/161,676

(22) Filed: Jan. 30, 2023

(51) Int. Cl. H04N 21/2343; G06F 3/14

(52) U.S. Cl. CPC H04N 21/2343; G06F 3/1454

(57) ABSTRACT

A computer-implemented method (CIM) of applying privacy filters to a screen share. The method includes the following operations: to establish a screen share between a first user and a second user, wherein the first user provides the screen share; to provide a privacy option, prior to the screen share with the second user, to the first user that offers at least one privacy filter to at least one portion of the screen share; the first user selects at least one privacy filter to the screen share; to apply the at least one privacy filter selected by the first user to the screen share; and to display the screen share to the second user with the at least one privacy filter applied to the screen share, wherein the at least one privacy filter masks the at least one portion of the screen share.

### BACKGROUND

The present disclosure relates generally to viewing content on computing devices during an online session, and more specifically, to applying user profile specific privacy rules on confidential data while screen sharing during the on-line session.

Video conferencing has become a prevalent mechanism for conducting conferences due, at least in part, to growth of high-speed networks, such as the Internet, and the proliferation of the use of video equipment. Video conferencing enables participants to share video and audio content with each other in real-time across geographically dispersed locations. For example, video conferencing commonly provides a screen sharing mode that allows a participant to share contents rendered on a display with other conference participants.

### SUMMARY

According to some embodiments of the disclosure, there is provided a computer-implemented method (CIM) of applying privacy filters to a screen share. The method includes an operation of establishing a screen share between a first user and a second user, wherein the first user provides the screen share. Another operation is providing a privacy option, prior to the screen share with the second user, to the first user that offers at least one privacy filter to at least one portion of the screen share, wherein the first user selects at least one privacy filter to the screen share. Yet a further operation is applying the at least one privacy filter selected by the first user to the screen share. A further operation is displaying the screen share to the second user with the at least one privacy filter applied to the screen share, wherein the at least one privacy filter masks the at least one portion of the screen share.

According to some embodiments of the disclosure, there is provided a system. The system includes a memory and a processor communicatively coupled to the memory, wherein the processor is configured to perform a method. The method includes an operation of establishing a screen share between a first user and a second user, wherein the first user provides the screen share. Another operation is providing a privacy option, prior to the screen share with the second user, to the first user that offers at least one privacy filter to at least one portion of the screen share, wherein the first user selects at least one privacy filter to the screen share. Yet a further operation is applying the at least one privacy filter selected by the first user to the screen share. A further operation is displaying the screen share to the second user with the at least one privacy filter applied to the screen share, wherein the at least one privacy filter masks the at least one portion of the screen share.

According to some embodiments of the disclosure, there is provided a computer program product comprising a computer readable storage medium having a computer readable program stored therein, wherein the computer readable program, when executed by a processor, causes the processor to perform a method. The method includes an operation of establishing a screen share between a first user and a second user, wherein the first user provides the screen share. Another operation is to provide a privacy option, prior to the screen share with the second user, to the first user that offers at least one privacy filter to at least one portion of the screen share, wherein the first user selects at least one privacy filter to the screen share. Yet a further operation is applying the at least one privacy filter selected by the first user to the screen share. A further operation is displaying the screen share to the second user with the at least one privacy filter applied to the screen share, wherein the at least one privacy filter masks the at least one portion of the screen share.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of a system for applying user profile specific privacy rules on confidential data while screen sharing during an on-line session, in accordance with some embodiments.

FIG. 2 illustrates a flow chart of a method for applying user profile specific privacy on confidential data while screen sharing during an online session, in accordance with some embodiments.

FIG. 3 illustrates a flow chart of a method for applying privacy filters to a screen share, in accordance with some embodiments.

FIG. 4 is a schematic diagram of a computing environment, in accordance with some embodiments.

FIG. 5 illustrates a block diagram, of a user profile privacy rules module of FIG. 4, in accordance with some embodiments.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate to viewing content on computing devices during an online session, and more specifically, to a method and system for applying user profile specific privacy rules on confidential data while screen sharing during the on-line session.

Screen sharing during an online meeting can result in all of the receivers or participants seeing the same content provided by a presenter. A processor associated with the presenter's computer can include a computer-readable medium with instructions stored thereon that can cause the processor to mask some contents of an application displayed during the screen sharing session to one or all of the receivers. The processor can include a privacy rules encoder, for example, in order to instruct the masking or unmasking of contents based on privacy rules.

According to an embodiment, a system, associated with presenting a video, online session to a set of receivers, can predefine privacy rules based on user profiles that are associated with the devices of the receivers during the online session. The user profiles can include relevant information, such as user role, user geographic location, physical characteristics of the user, etc. The system can mask some of the shared contents in a screen share provided to one or more of the receivers based on one or more aspects of the relevant information from their user profiles. The receivers can see different content in the screen share dependent upon their user profiles. In some embodiments, the system can detect dynamic changes in the user profile and can change the masking of the content in screen shares dynamically on the fly during an online session. For example, if the system detects a change in geographic location of a receiver, then the privacy rules relating to that receiver can be dynamically changed by the system. As a result, a screen share can have differently masked content than it would have if the receiver was in their previous geographic location.

One feature and advantage of the disclosed systems and methods is that shared content in a screen share can be masked properly based on each intended receiver without a presenter having to individually address each receiver. The presenter can choose privacy rules or filters that can be compared by the system to each receiver's user profile to mask shared content based on the rules and aspects of the user's profile for each receiver. The shared screen can look different for different receivers based on their user profiles and what they are deemed able to view and what is confidential.

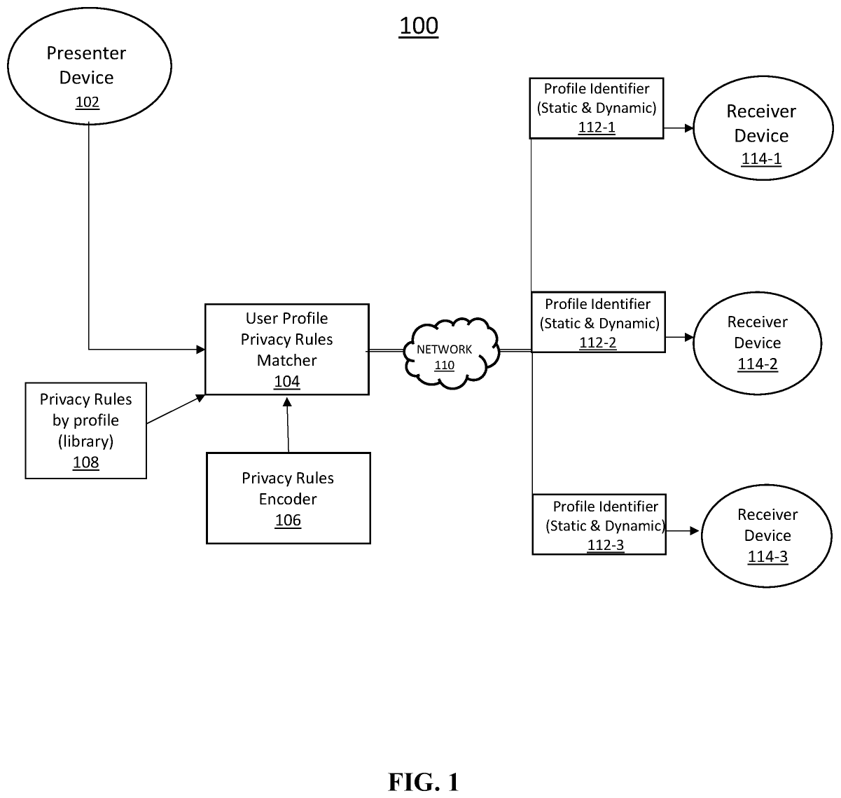

Turning to the figures, FIG. 1 is a block diagram of an example system 100 that can be used to apply user profile specific privacy rules on confidential data while screen sharing during an on-line session, in accordance with some embodiments. As shown, system 100 includes a presenter device 102, which can include a monitor, a computing device, etc., in order to present contents of an online session and share its screen. The presenter device 102 can be communicatively coupled to one or more receiver devices 114-1 to 114-3 (individually referred to herein as receiver device 114 or collectively referred to herein as receiver devices 114-1 to 114-3) via a network 109. The network 109 can be a local area network (LAN), a wide area network (WAN), the Internet, and/or other wires or wireless networks. The number of receiver devices 114 depicted in the system 100 is for illustration, and those skilled in the art will appreciate that there can be a different number of receiver devices 114, including very large numbers of receiver devices 114 (e.g., tens, hundreds, or thousands of such receiver devices 114). Also, in other embodiments, the system 100 may not have all of the elements shown in FIG. 1 and/or can have other elements including other types of elements instead of, or in addition to, some or all of the elements shown in FIG. 1. For example, the system 100 can include more than one presenter device 102.

The presenter device 102 enables video conferencing to occur between the presenter device 102 and the receiver devices 114-1 to 114-3. The video conferencing can include different types of media streams (e.g., video streams, audio streams, text, audio, images, animations, video, and interactive content).

A screen share feature is a feature where a participant (referred to as a sharing participant, for example, an online conference presenter) displays his or her screen (e.g., content being displayed on his or her screen, or a selected portion or portions of the screen) in the video stream such that other participants in the video conference session can see content that the sharing participant has displayed on a screen of his or her display (i.e., the sharing participant's screen is made available (or “shared”) for other participants to view the content thereon). For instance, the content being shared by the presenter can be displayed on the screens of the receiver devices 114-1 to 114-3 of the other participants in the video conference session.

The system 100 can configure “privacy rules” that can define content that is considered to be sensitive information and how the sensitive information is to be masked or shielded from the receiver devices 114-1 to 114-3 when performing screen sharing by the presenter device 102. Prior to activating a screen share feature or after the screen share feature is commenced, the presenter device 102 can activate a user profile privacy rules matcher 104. The user profile privacy rules matcher 104 is a component configured to perform a method in which a user profile or user profiles is/are detected, such as role, gender, geographic location, etc., and appropriate privacy filters are selected before sending or displaying content to that particular receiver or receivers. The user profile privacy rules matcher 104 can access a set of privacy rules by profile (library) 108. The “library” is a predefined set of privacy rules that are defined based on various factors such as what data may be shared, and what content needs to be masked based on portions of a receiver's profile, etc. The user profile privacy rules matcher 104 can also access a privacy rules encoder 106. The privacy rules encoder 106 is a component configured to perform a method in which a user/presenter can dynamically tune in some privacy rules that are not predefined and which can be applied to an ongoing session. Privacy rules are defined as rules by which action or masking are defined depending on a certain content match while screen sharing. For example, if a receiver holds a particular role, then their user name and password can be masked. Another example is if a receiver resides in a certain country, then certain content in a presentation can be hidden or masked during a screen share. Through the network 110, the user profile privacy rules matcher 104 can access each one of a plurality of profile identifiers 112-1 to 112-3 (both statically and dynamically) that are each associated with one of the receiver devices 114-1 to 114-3. A profile identifier 112 is a component configured to perform a method that identifies various factors associated with a remote receiver which includes, but is not limited to, role, geographic location, time, physical characteristics of the user, etc. The profile identifiers 112-1 to 112-3 provide the information in a user profile associated with each user operating each receiver device 114-1 to 114-3. The user profile can include, for example, the user's role in an organization, their physical characteristics, their geographic location, etc. Other information relating to the user of the receiver device can also be included in the user profile and the pertinent information is not limited to that described herein. Access or lack of access to certain information in an online session communicated from the presenter device 102 can depend upon the user profile characteristics of each user associated with each receiver device 114-1 to 114-3.

The presenter device 102 can process the video stream being displayed on the screens of the receiver devices 114-1 to 114-3 in order to identify items of sensitive information included in the content based on the privacy rules and the user profiles. The presenter device 102 can obfuscate or mask the identified items in the video stream according to the privacy rules. For example, in the case where the privacy rules indicate that identified items of sensitive information are included, the presenter device 102 can then transmit the processed video stream showing the identified items of sensitive information in masked or obfuscated form to the receiver devices 114-1 to 114-3 of conference participants.

In some embodiments, identification of items of sensitive information includes a masking indication, where a masking indication is an indication that indicates the specific components are not to be visible (i.e., are to be masked) during a screen sharing session. In an embodiment, sensitive information can be masked by text, icons, objects, or other types of content in each component can be changed to match the color of the background color of the component. In another embodiment, the component of the application identified with the masking indication is masked by replacing the component identified with the masking indication with at least one of a solid color and a pattern. Other suitable methods of masking text or other confidential components of a shared session are contemplated.

In some embodiments, identification of components of a screen can be dynamically determined to be displayed during a screen sharing session or to be masked during the screen sharing session. According to some embodiments, a source code can apply a set of configurable privacy rules to dynamically determine whether a component is to be displayed or masked during a screen sharing session.

In some embodiments, the privacy rules can be applied using artificial intelligence (AI). In some embodiments, the presenter can select/deselect the receiver device to receive confidential data or have confidential data masked. The selection/deselection process can occur anytime during the online session and on the fly to apply privacy rules. In some embodiments, aspects of an online session can be shared with specific receivers and not shared with some of the receivers. The shared content can be selectively masked, for example, based on the receiver's geographic location, physical characteristics, etc. As an example, some European data may not be allowed outside of Europe. In that case, the European data can be masked to those receivers in an online session that are located outside of Europe.

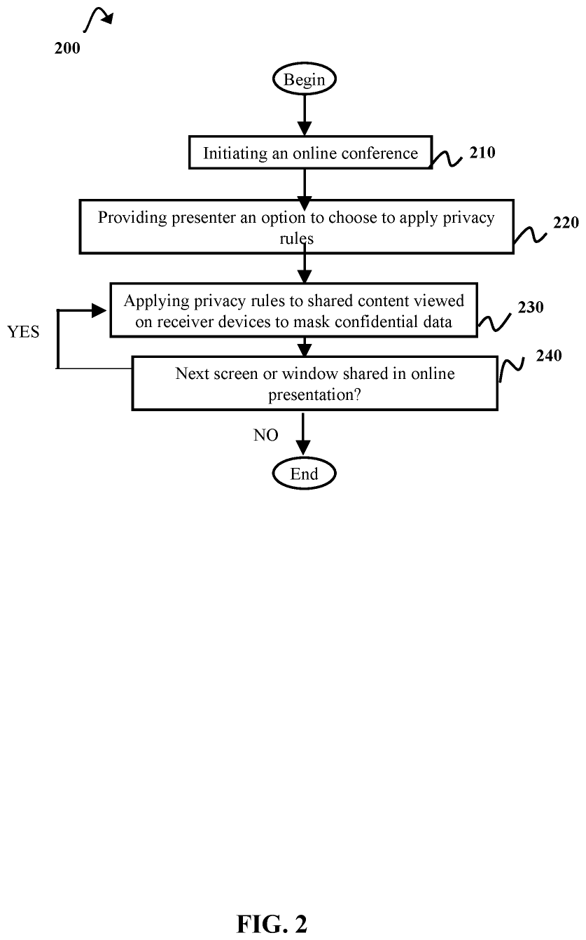

FIG. 2 a flow chart of a method 200 for applying user profile specific privacy on confidential data while screen sharing in an online session, in accordance with some embodiments. An operation 210 in the method or process 200 is to initiate an online conference that includes screen sharing from a presenter device 102 (in FIG. 1) with a plurality of communicatively coupled receiver devices 114-1 to 114-3 (in FIG. 1). During the online conference, another operation 220 of the process 200 is to provide an option to the presenter device 102 (in FIG. 1) to allow the presenter to choose to apply privacy rules. For example, the presenter can be provided an option to choose fields on which the presenter wants to apply the privacy rules. Internal drivers of screen sharing/recording technology can take note of the chosen fields and can start performing the privacy rules on the fly based on aspects of user profiles associated with the receiver devices 114-1 to 114-3 (in FIG. 1). Another operation 230 is to apply the privacy rules to shared content viewed on the receiver devices 114-1 to 114-3 (in FIG. 1) to mask confidential data based upon the privacy rules, and the user profiles associated with the receiver devices 114-1 to 114-3 (in FIG. 1). Another operation 240 is to determine if a next screen or window is shared in the online presentation. If so, whenever the presenter switches or proceeds to a next screen or window that he/she wants to share, an opportunity is provided to the presenter to define privacy rules on the shared content on the next screen or window. If there are no additional screens or windows shared in the online presentation, the process 200 can end.

In some embodiments, the participants in an online session can be called a presenter (or presenters) and receivers of the shared screens of the online session. However, in other embodiments, the presenter and receivers can more generally be referred to as “users.” A “user” can be any participant in the online session that can be providing or receiving a screen share during an online session.

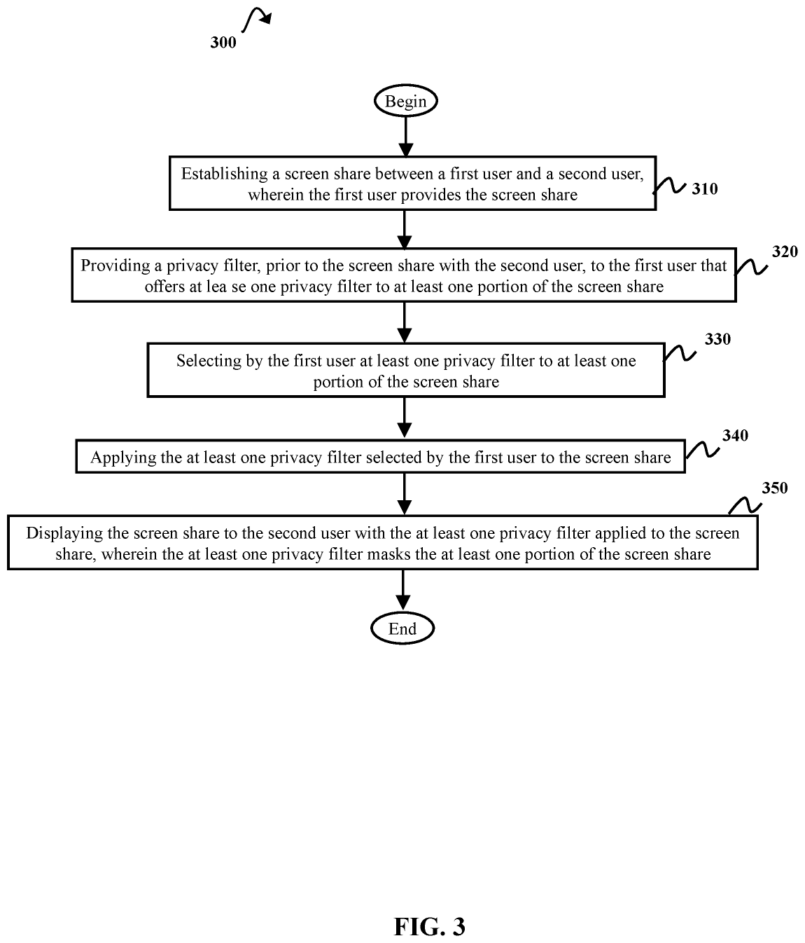

FIG. 3 is a flow chart of a method or process 300 for applying privacy filters to a screen share, in accordance with some embodiments. An operation 310 in the process 300 is to establish a screen share between a first user and a second user. The first user provides the screen share. An operation 320 is to provide a privacy option, prior to the screen share with the second user, to the first user that offers at least one privacy filter to at least one portion of the screen share. The privacy option can be a screen or window provided to a computing device used by the first user that includes a plurality of privacy filters that can be selectively chosen and applied to information included in the screen share. The privacy filters are otherwise known as privacy rules that can be applied. Another operation 330 is the first user selects at least one privacy filter to the screen share. Yet another operation 340 is to apply the at least one privacy filter selected by the first user to the screen share. A further operation 350 is to display the screen share to the second user with the at least one privacy filter applied to the screen share, wherein the at least one privacy filter masks the at least one portion of the screen share.

In the process 300, the privacy option can provide additional options that allow the at least one privacy filter to be applied to the screen shares of some the additional users while excluding the screen shares of some of the additional users. Also, in some embodiments of the process 300, the at least one privacy filter can be adapted to mask the at least one portion of the screen share based on aspects of a user profile of the second user. The aspects of the user profile can include geographic location of the second user, physical characteristics of the second user, and role of the second user. The establishing the screen share step of the process 300 can be carried out by a presenter device in order to present contents of an online session and share its screen. The presenter device can be communicatively coupled to a plurality of receiver devices operated by the second user and the additional users. When the screen share has changed its content, the process 300 can include the first user selecting at least one privacy filter to the changed screen share, applying the at least one privacy filter selected by the first user to the changed screen share, and displaying the screen share to the second user with the at least one privacy filter applied to the changed screen share, wherein the at least one privacy filter masks the at least one portion of the changed screen share.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

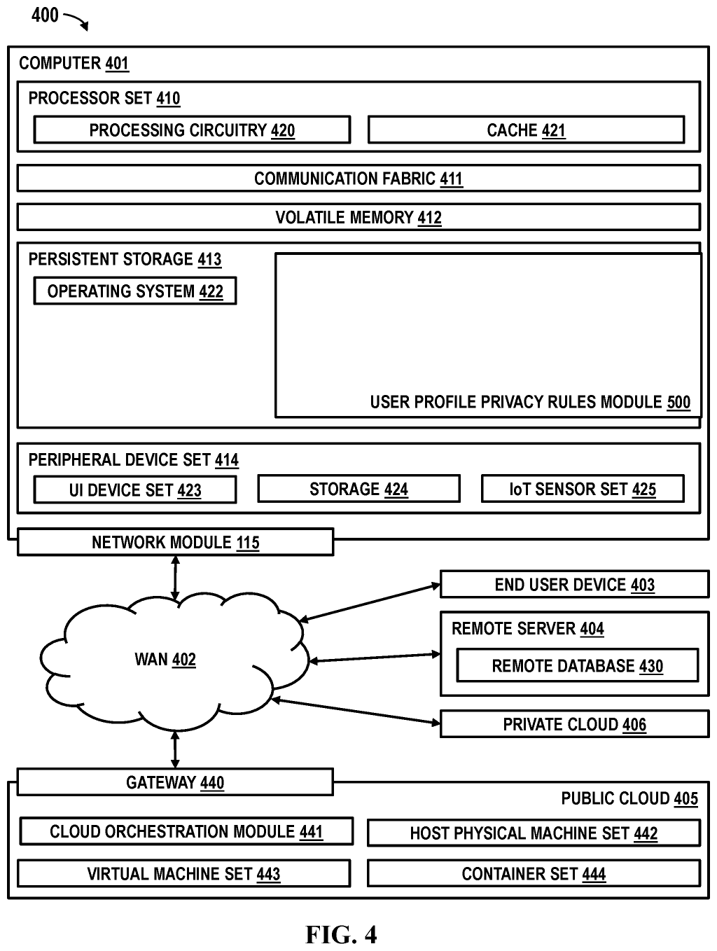

As shown in FIG. 4, computing environment 400 contains an example of an environment for the execution of at least some of the computer code involved in performing the disclosed methods, such as user profile privacy rules module 500. In addition to block 500, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 500, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 421 and the other storage media discussed below. The program instructions, and associated data, are accessed by processor set 410 to control and direct performance of the disclosed methods. In computing environment 400, at least some of the instructions for performing the disclosed methods may be stored in block 500 in persistent storage 413.

Communication fabric 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 500 typically includes at least some of the computer code involved in performing the disclosed methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the disclosed methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

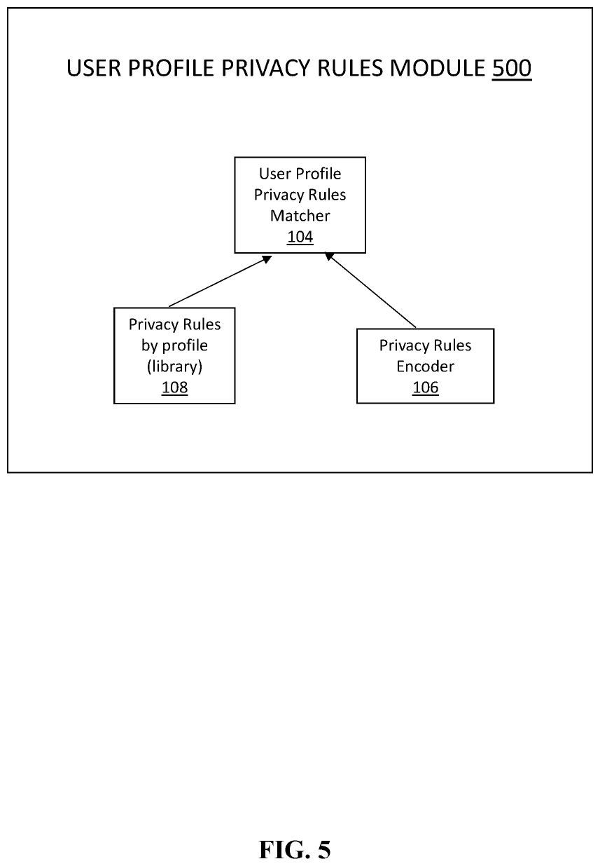

FIG. 5 illustrates a block diagram, of a user profile privacy rules module 500, in accordance with some embodiments. The user profile privacy rules module 500 includes a user profile privacy rules matcher 104. The user profile privacy rules matcher 104 can access a set of privacy rules by profile (library) 108, and a privacy rules encoder 106.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A computer-implemented method (CIM) of applying privacy filters to a screen share, the method comprising:
establishing a screen share between a first user, a second user, and a third user, wherein the first user provides the screen share;
providing a privacy option, prior to the screen share with the second user and the third user, to the first user that offers at least one privacy filter to at least one portion of the screen share, wherein the first user selects the at least one privacy filter to the screen share and the first user selects fields of the screen share on which to apply the at least one privacy filter;
applying the at least one privacy filter selected by the first user to the screen share based on a user profile of the second user and a user profile of the third user;
displaying the screen share to the second user with the at least one privacy filter applied to the screen share, wherein the at least one privacy filter masks the at least one portion of the screen share;
displaying the screen share to the third user, wherein the at least one portion of the screen share is unmasked to the third user;
detecting dynamic changes in the user profile of the second user or the user profile of the third user; and
when the dynamic changes are detected, changing masking of the at least one portion of the screen share dynamically on the fly during an online session.

2. The CIM of claim 1, further comprising:
establishing a screen share between the first user and a plurality of additional users, wherein the first user provides the screen share to the plurality of additional users; and
displaying the screen share to the plurality of additional users with the at least one privacy filter applied to the screen share, wherein the at least one privacy filter is capable of masking the at least one portion of the screen share provided to one or more of the plurality of additional users.

3. The CIM of claim 1, wherein the at least one privacy filter is adapted to mask the at least one portion of the screen share based on aspects of the user profile of the second user.

4. The CIM of claim 3, wherein the aspects of the user profile include geographic location of the second user, and role of the second user.

5. The CIM of claim 1, wherein the establishing the screen share step can be carried out by a presenter device in order to present contents of the online session and share its screen.

6. The CIM of claim 5, wherein the presenter device can be communicatively coupled to a plurality of receiver devices operated by the second user and a plurality of additional users.

7. The CIM of claim 1, wherein when the screen share has changed its content, further comprising:
selecting by the first user at least one privacy filter to the changed screen share;
applying the at least one privacy filter selected by the first user to the changed screen share; and
displaying the screen share to the second user with the at least one privacy filter applied to the changed screen share, wherein the at least one privacy filter masks the at least one portion of the changed screen share.

8. A computer system for applying privacy filters to a screen share, the computer system comprising:
one or more processors, one or more computer-readable memories and one or more computer-readable storage media;
program instructions, stored on at least one of the one or more storage media for execution by at least one of the one or more processors via at least one of the one or more memories, to establish a screen share between a first user, a second user, and a third user, wherein the first user provides the screen share;
program instructions, stored on at least one of the one or more storage media for execution by at least one of the one or more processors via at least one of the one or more memories, to provide a privacy option, prior to the screen share with the second user and the third user, to the first user that offers at least one privacy filter to at least one portion of the screen share, wherein the first user selects the at least one privacy filter to the screen share and the first user selects fields of the screen share on which to apply the at least one privacy filter;
program instructions, stored on at least one of the one or more storage media for execution by at least one of the one or more processors via at least one of the one or more memories, to apply the at least one privacy filter selected by the first user to the screen share based on a user profile of the second user and a user profile of the third user;
program instructions, stored on at least one of the one or more storage media for execution by at least one of the one or more processors via at least one of the one or more memories, to display the screen share to the second user with the at least one privacy filter applied to the screen share, wherein the at least one privacy filter masks the at least one portion of the screen share;
program instructions, stored on at least one of the one or more storage media for execution by at least one of the one or more processors via at least one of the one or more memories, to display the screen share to the third user, wherein the at least one portion of the screen share is unmasked to the third user;
program instructions, stored on at least one of the one or more storage media for execution by at least one of the one or more processors via at least one of the one or more memories, to detect dynamic changes in the user profile of the second user or the user profile of the third user; and
when the dynamic changes are detected, program instructions, stored on at least one of the one or more storage media for execution by at least one of the one or more processors via at least one of the one or more memories, to change masking of the at least one portion of the screen share dynamically on the fly during an online session.

9. The computer system of claim 8, further comprising:
program instructions, stored on at least one of the one or more storage media for execution by at least one of the one or more processors via at least one of the one or more memories, to establish a screen share between the first user and a plurality of additional users, wherein the first user provides the screen share to the plurality of additional users; and
program instructions, stored on at least one of the one or more storage media for execution by at least one of the one or more processors via at least one of the one or more memories, to display the screen share to the plurality of additional users with the at least one privacy filter applied to the screen share, wherein the at least one privacy filter is capable of masking the at least one portion of the screen share provided to one or more of the plurality of additional users.

10. The computer system of claim 8, wherein the at least one privacy filter is adapted to mask the at least one portion of the screen share based on aspects of the user profile of the second user.

11. The computer system of claim 10, wherein the aspects of the user profile include geographic location of the second user, and role of the second user.

12. The computer system of claim 8, wherein the establish the screen share step can be carried out by a presenter device in order to present contents of the online session and share its screen.

13. The computer system of claim 12, wherein the presenter device can be communicatively coupled to a plurality of receiver devices operated by the second user and a plurality of additional users.

14. The computer system of claim 8, wherein when the screen share has changed its content, further comprising:
program instructions, stored on at least one of the one or more storage media for execution by at least one of the one or more processors via at least one of the one or more memories, to select by the first user at least one privacy filter to the changed screen share;
program instructions, stored on at least one of the one or more storage media for execution by at least one of the one or more processors via at least one of the one or more memories, to apply the at least one privacy filter selected by the first user to the changed screen share; and
program instructions, stored on at least one of the one or more storage media for execution by at least one of the one or more processors via at least one of the one or more memories, to display the screen share to the second user with the at least one privacy filter applied to the changed screen share, wherein the at least one privacy filter masks the at least one portion of the changed screen share.

15. A computer program product for applying privacy filters to a screen share, the computer program product comprising:
one or more computer-readable storage media;
program instructions, stored on at least one of the one or more storage media, to establish a screen share between a first user, a second user, and a third user, wherein the first user provides the screen share;
program instructions, stored on at least one of the one or more storage media, to provide a privacy option, prior to the screen share with the second user and the third user, to the first user that offers at least one privacy filter to at least one portion of the screen share, wherein the first user selects the at least one privacy filter to the screen share and the first user selects fields of the screen share on which to apply the at least one privacy filter;
program instructions, stored on at least one of the one or more storage media, to apply the at least one privacy filter selected by the first user to the screen share based on a user profile of the second user and a user profile of the third user;
program instructions, stored on at least one of the one or more storage media, to display the screen share to the second user with the at least one privacy filter applied to the screen share, wherein the at least one privacy filter masks the at least one portion of the screen share;
program instructions, stored on at least one of the one or more storage media, to display the screen share to the third user, wherein the at least one portion of the screen share is unmasked to the third user;
program instructions, stored on at least one of the one or more storage media, to detect dynamic changes in the user profile of the second user or the user profile of the third user; and
when the dynamic changes are detected, program instructions, stored on at least one of the one or more storage media, to change masking of the at least one portion of the screen share dynamically on the fly during an online session.

16. The computer program product of claim 15, further comprising:
program instructions, stored on at least one of the one or more storage media, to establish a screen share between the first user and a plurality of additional users, wherein the first user provides the screen share to the plurality of additional users; and
program instructions, stored on at least one of the one or more storage media, to display the screen share to the plurality of additional users with the at least one privacy filter applied to the screen share, wherein the at least one privacy filter is capable of masking the at least one portion of the screen share provided to one or more of the plurality of additional users.

17. The computer program product of claim 15, wherein the at least one privacy filter is adapted to mask the at least one portion of the screen share based on aspects of the user profile of the second user.

18. The computer program product of claim 17, wherein the aspects of the user profile include geographic location of the second user, and role of the second user.

19. The computer program product of claim 15, wherein the establish the screen share step can be carried out by a presenter device in order to present contents of the online session and share its screen.

20. The computer program product of claim 19, wherein the presenter device can be communicatively coupled to a plurality of receiver devices operated by the second user and a plurality of additional users.
